(19) United States
(12) Patent Application Publication
(10) Pub. No.: US 2012/0072351 A1
(43) Pub. Date: Mar. 22, 2012

(54) METHOD FOR GENERATING EMR WITHOUT ALTERING HIS IN AN ADDITIONAL FASHION

(76) Inventors: Ying-Hsiang Yao, Taipei City (TW); Cheng-Ta Lee, Taichung City (TW); Chih-Hone Li, Taichung City (TW)

(21) Appl. No.: 12/886,878

(22) Filed: Sep. 21, 2010

(51) Int. Cl. G06Q 50/00; H04L 9/28; G06Q 10/00

(52) U.S. Cl. 705/50; 705/3

(57) ABSTRACT

A method for generating electronic medical records (EMR) without altering hospital information system (HIS) in an additional fashion aims to meet requirements of accelerating integration of HIS and implementing EMR in hospitals that gradually adopt EMR. The method of the invention realizes the advantages of system integration and greater usability of electronic medical record system while avoiding the pitfalls thereof. The method provided by the invention captures a traditional medical record from an output of an existing HIS in an additional or information system integration fashion, and systematically arranges, stores and converts the traditional medical record without greatly altering the HIS.

### FIELD OF THE INVENTION

The present invention relates to a method for generating electronic medical records (EMR) and particularly to a method to capture traditional medical records (including paper-based medical records) from an output of an existing hospital information system (HIS) and convert to an electronic medical record in an additional or information system integration fashion.

### BACKGROUND OF THE INVENTION

Adopting EMR is a prevailing international trend in modern society and a highly promoted public policy in our country in recent years. The conventional approach for implementing such a practice generally adopts extensive alterations, modifications or enhancement of HIS used in medical institutions or hospitals. For instance, R.O.C. patent No. 1222354 entitled “Portable medicine order system” employs a Personal Digital Assistant (PDA) to download patient's medical records from a hospital database, and make a new medicine order return to the hospital database when diagnosis is finished. The PDA is portable and allows doctors to check and update patient's data anytime anywhere, thus enables the doctors to grasp patient's conditions constantly.

R.O.C. patent No. 1297873 entitled “Method for protecting completeness and accuracy of digital documents” adopts the concept of composite documents by designing a document structure to store EMR and providing a multi-layer inspection code processing method to achieve effective protection of multiple related and serial documents in terms of completeness and accuracy.

However, the aforesaid two prior arts involve extensive alterations, modifications or enhancement of software/hardware interfaces of HIS, and a wholesale implementation of electronic HIS has to be executed. While such a conversion to EMR provides the benefits of easier management and higher circulation, and overall implementation of EMR also is under government's planning. In practice, the existing HIS has been established, maintained and updated for a long period of time, to make large scale alterations, modifications or enhancement of HIS to generate EMR will cost huge amount of manpower, resources and expenses. Moreover, unpredictable defects, pitfalls and risks of altering HIS to generate EMR cannot be fully excluded. Patients' life could be threatened in serious situations, and the consequence could be very severe.

In addition, the formats of EMR adopted by various HIS are not fully coincided, and compatibility is also a big issue. Different providers of EMR often develop their own software and systems for different medical systems that are not fully compatible. Hence the EMR cannot be commonly shared and used in different systems.

### SUMMARY OF THE INVENTION

The primary object of the present invention is to solve the disadvantages of conventional wholesale implementation of EMR that result in a higher cost and greater investments in manpower and time.

Another object of the invention is to eliminate the risks of efficiency impact and format incompatibility incurred to the generated EMR by altering HIS in the conventional wholesale implementation of EMR.

Yet another object of the invention is to solve the problem of altering the original programs during implementation of EMR in hospitals by providing a method to realize EMR in hospitals without altering the existing HIS.

The present invention provides a method for generating EMR without altering the HIS in an additional fashion. The method according to the invention captures a traditional medical record from an output of the existing HIS in an additional or information system integration fashion, and systematically arranges and stores the traditional medical record in an electronic medical record without greatly altering the HIS. The method mainly includes steps as follow:

capturing directly user's medical data from an existing HIS output, or capturing a traditional medical record output through printing, files or electronic signals and converting the medical data or medical record to become preparation data; and

proceeding with a post processing step including operations of identification, conversion, standard mapping, encryption, electronic signature, compression and data exchange of the preparation data, and save data in prior and post processing steps if necessary.

By means of the foregoing processes, the invention is integrated with the existing HIS through an additional or information system integration fashion without replacing a great deal of system equipment, and can eliminate or save a great amount of cost in analysis, design, implementation and test incurred to alterations, modifications or enhancement of the HIS. Moreover, the EMR exchange format could be configured and defined to integrate with the generic HIS. Compared with the traditional approach of wholesale alteration, modification or enhancement of the HIS, the present invention maintains the conventional HIS and medical records. The invention, aside from easily generating the medical records and enhancing circulation, also can gradually convert the traditional medical records (including paper-based medical records) or medical data of HIS to the EMR to save time, efforts and cost.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a flowchart of an embodiment of the method of the invention.

FIG. 2 is a flowchart of an embodiment of the post processing step of the invention.

FIG. 3 is a block diagram of an embodiment to carry out the post processing step of the invention.

### DETAILED DESCRIPTION OF THE PREFERRED EMBODIMENTS

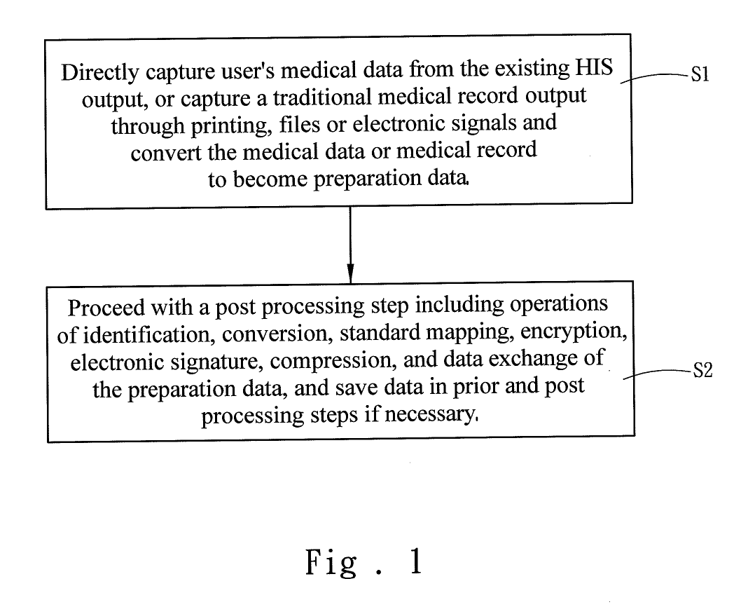

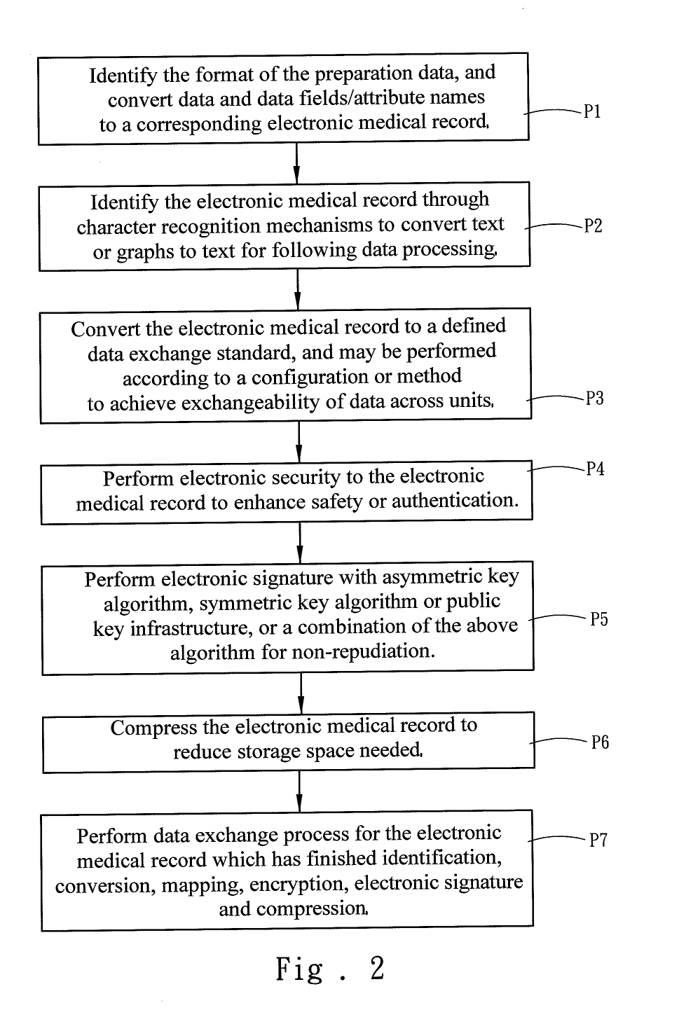

Please refer to FIGS. 1 and 2 for the flowchart of an embodiment of the invention. The method for generating EMR according to the invention adopts an additional or information system integration approach by capturing a traditional medical record from an output of an exist HIS, and systematically arranging and saving the traditional medical record to an electronic medical record without greatly altering the HIS. A user enters medical data in the existing HIS to output a traditional medical record by printing, filing or formed in electronic signals. The method of the invention mainly includes the following steps:

S1: Directly capture user's medical data from the existing HIS output, or capture a traditional medical record output through printing, files or electronic signal by reading, receiving, scanning, photographing or intercepting, and convert the medical data or medical record to become preparation data. The traditional medical record is selected from the group consisting of text paper, graphic paper and medical equipment output. The captured medical data or traditional medical record is transmitted selectively through print port, universal serial bus (USB), serial port, network port, or output interface of operation system. The captured medical data and traditional medical record are output through a document or photo output device which is selected from the group consisting of virtual printer, real printer, copy machine, scanner, barcode reader, and labeling machine. In this embodiment, the medical data include an electrocardiogram, an electroencephalogram or electronic data output through instruments; and

S2: Proceed with a post processing step including operations of identification, conversion, standard mapping, encryption, electronic signature, compression, and data exchange of the preparation data, and save data in prior and post processing steps if necessary.

More specifically, the post processing step further includes the following steps:

P1: Identify the format of the preparation data, and convert data and data fields/attribute names to a corresponding electronic medical record;

P2: Identify the electronic medical record through character recognition mechanisms to convert text or graphs to text for following data processing;

P3: Convert the electronic medical record to a defined data exchange standard, and may be performed according to a configuration or method to achieve exchangeability of data across units;

P4: Perform electronic security to the electronic medical record to enhance safety or authentication;

P5: Perform electronic signature with asymmetric key algorithm, symmetric key algorithm or public key infrastructure, or a combination of the above algorithm for non-repudiation.

P6: Compress the electronic medical record to reduce storage space needed; and

P7: Perform data exchange process for the electronic medical record which has finished identification, conversion, standard mapping, encryption, electronic signature and/or compression.

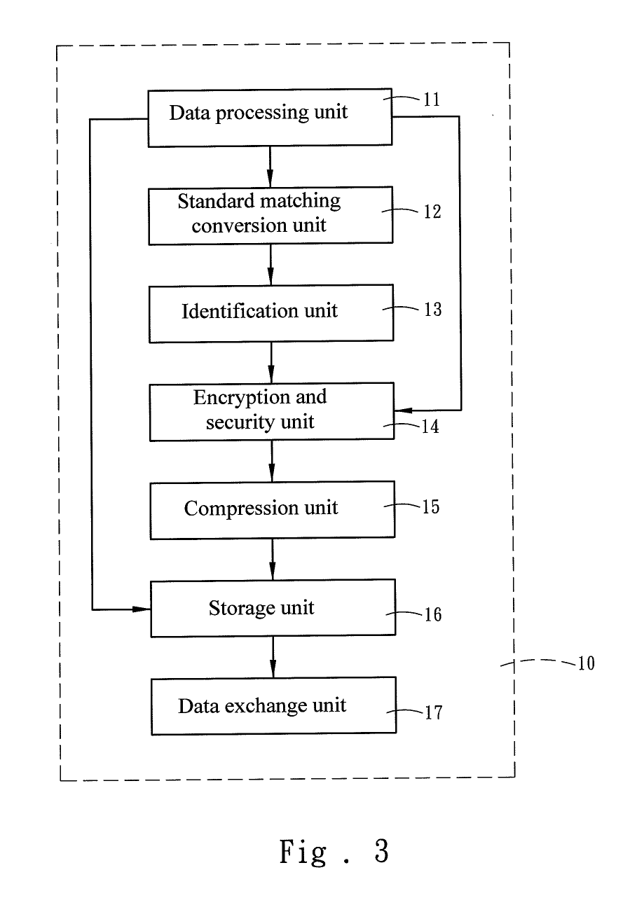

Refer to FIG. 3 for the block diagram of an embodiment to carry out the post processing step of the invention. It contains a post processing module 10 which includes a data processing unit 11, a standard mapping conversion unit 12, an identification unit 13, an encryption security unit 14, a compression unit 15, a storage unit 16 and a data exchange unit 17. The data processing unit 11 converts data and data fields/attribute names to a corresponding electronic medical record. The standard mapping conversion unit 12 is located in the post processing module 10 to convert the data of the electronic medical record to a defined data exchange standard to facilitate data exchangeability across units. The identification unit 13 recognizes the preparation data through character recognition mechanisms to convert text or graphs to text for following data processing. The encryption security unit 14 signs or performs electronic security and electronic signature on the electronic medical record to enhance safety, authentication and non-repudiation, and can perform encryption or electronic signature combined with a symmetric key algorithm, asymmetric key algorithm or public key infrastructure. The compression unit 15 compresses the electronic medical record to reduce storage space needed. The storage unit 16 stores the electronic medical record. The data exchange unit 17 performs data exchange for the electronic medical record through a data exchange mechanism and method.

In this embodiment, the post processing module 10 is organized and processes in sequence. The data processing unit 11 is connected to the standard mapping conversion unit 12 which provides the electronic medical record with text or graphs recognized by the identification unit 13; then the encryption security unit 14 performs encryption and electronic signature; thereafter the compression unit 15 compresses the electronic medical record to reduce storage space, and the storage unit 16 stores the electronic medical record; finally the data exchange unit 17 performs data exchange of the stored electronic medical record. However, in practice, the processing steps can be changed according to actual requirements, they are not limited to the sequence in previously discussed embodiment. Moreover, the unit elements in the post processing module can be removed or added according to actual requirements.

In a conclusion, the method of the invention provides an additional or information system integration approach combined with the existing HIS without extensive alterations, modifications or enhancement of HIS, without replacing a lot of system equipment, and also can eliminate or greatly save the costs involved in analysis, design, implementation and test. The EMR exchange format could be configured and defined to integrate with the generic HIS. Compared with the conventional approach of greatly altering the HIS used in medical institutions or hospitals, the present invention maintains the conventional HIS and medical records commonly used. Generation of the electronic medical record through the invention is easier, and circulation is higher. Moreover, the invention can gradually convert the traditional medical records (including paper-based medical records) or medical data of the HIS to EMR to save time, manpower and cost.

In summation of the above description, the present invention provides a significant improvement over the conventional techniques and complies with the patent application requirements, and is submitted for review and granting of the commensurate patent rights.

While the invention has been described by means of specific embodiments, numerous modifications and variations could be made thereto by those skilled in the art without departing from the scope and spirit of the invention set forth in the claims.

What is claimed is:

1. A method for generating electronic medical records (EMR) without altering hospital information system (HIS) in an additional fashion allowing a user to capture a traditional medical record from an output of an existing HIS through an additional or an information system integration fashion and systemically arrange and store the traditional medical record to form an electronic medical record, comprising the steps of:
directly capture user's medical data from the existing HIS output, or capture a traditional medical record output through printing, files or electronic signals and convert the medical data or medical record to become preparation data; and
proceed with a post processing step including operations of identification, conversion, standard mapping, encryption, electronic signature, compression, and data exchange of the preparation data, and save data in prior and post processing steps if necessary.

2. The method of claim 1, wherein capturing the user's medical data and the traditional medical record are performed selectively by reading, receiving, scanning, photographing or intercepting.

3. The method of claim 1, wherein the traditional medical record is selected from the group consisting of text paper, graphic paper and medical equipment output.

4. The method of claim 1, wherein the captured medical data or the traditional medical record is selectively transmitted through a print port, a universal serial bus (USB), a serial port, a network port, or an output interface of operation system.

5. The method of claim 1, wherein the captured medical data and the traditional medical record are output through a document or photo output device.

6. The method of claim 5, wherein the document output device is selected from the group consisting of a virtual printer, a real printer, a copy machine, a scanner, a barcode reader and a labeling machine.

7. The method of claim 1, wherein the medical data is selectively an electrocardiogram or an electroencephalogram.

8. The method of claim 1, wherein the identification operation in the post processing step converts text or graphs of the preparation data through character recognition mechanisms to become text for following data processing; the standard mapping operation in the post processing step converting the preparation data to a defined data exchange standard according to a configuration or method to achieve exchangeability of data across units; the encryption and electronic signature operations in the post processing step performing electronic security and electronic signature on the preparation data to enhance safety, authentication and non-repudiation of the electronic medical record; the compression operation in the post processing step compressing the preparation data to reduce storage space needed; and the data exchange operation in the post processing step exchanging the electronic medical record through a data exchange mechanism.

9. The method of claim 1, wherein the encryption and electronic signature operations in the post processing step signs the preparation data selectively through a symmetric key algorithm, an asymmetric key algorithm or a public key infrastructure.

10. The method of claim 1, wherein the encryption and electronic signature operations in the post processing step signs the preparation data through a symmetric key algorithm, an asymmetric key algorithm or a public key infrastructure in combination.
